(19) United States
(12) Patent Application Publication
(10) Pub. No.: US 2017/0213513 A1
(43) Pub. Date: Jul. 27, 2017

(54) LCD ADOPTING GATE DRIVER ON ARRAY SUBSTRATE PREVENTING FROM BURNOUT

(71) Applicant: SHENZHEN CHINA STAR OPTOELECTRONICS TECHNOLOGY CO., LTD., Shenzhen, Guangdong (CN)

(72) Inventors: Pingsheng KUO, Shenzhen (CN); Liwei CHU, Shenzhen (CN); Mingwei CHEN, Shenzhen (CN); Dan CAO, Shenzhen (CN)

(73) Assignee: SHENZHEN CHINA STAR OPTOELECTRONICS TECHNOLOG CO., LTD., Shenzhen, Guangdong (CN)

(21) Appl. No.: 14/891,191

(22) PCT Filed: Sep. 8, 2015
(86) PCT No.: PCT/CN2015/089154

§ 371 Date: Nov. 13, 2015

(30) Foreign Application Priority Data
Aug. 13, 2015 (CN) 201510493355.3

(51) Int. Cl. G09G 3/36

(52) U.S. Cl. CPC G09G 3/3677; G09G 3/3688; G09G 2310/08; G09G 2300/0408; G09G 2310/0289; G09G 2320/046

(57) ABSTRACT

An LCD includes a substrate including a pixel array section and a circuit arrangement section arranged on a first side and a second side of the pixel array section. The LCD further includes: gate driving units disposed on the circuit arrangement section for outputting a scanning signal to the pixel array section based on a voltage level of clock signal and a voltage level of controlling signal, a sensing circuit for outputting an adjusting signal when an output signal output by the gate driving unit at the last stage is smaller than a predetermined value, and a level shifter for outputting clock signal at a low voltage level and controlling signal at a low voltage level to the plurality of gate driving units when receiving the adjusting signal. Meanwhile, the data transmission is terminated. Therefore, the LCD is turned off for a while, preventing from being burnt out.

### BACKGROUND OF THE INVENTION

1. Field of the Invention

The present invention relates to a liquid crystal display (LCD), and more particularly, to an LCD adopting a gate driver on array (GOA) substrate.

2. Description of the Prior Art

Liquid crystal displays, on account of their high resolution requirement, are widely applied to various electronic devices, such as mobile phones, personal digital assistants, digital cameras, computer displays, and notebook computer displays.

A conventional LCD comprises a source driver, a gate driver, and an LCD panel. The gate driver is comprises a shift register, a logic circuit, a level shifter, and a digital buffer for the design of conventional LCD panels. The shift register is mainly used for outputting a scanning signal to the LCD panel at every fixed interval. As for an LCD panel with the resolution of 1024×768, the red (R), green (G), and blue (B) sub-pixels are arranged horizontally. Take the refresh rate of 60 Hz for example. The display time of each frame is about 1/60=16.67 ms. So the pulse of each scanning signal is about 16.67 ms/768=21.7 μs. The pixels are charged and discharged to a required voltage for showing corresponding grayscales on the time of 21.7 ∥s with the source driver.

To produce an LCD with a narrow border, the gate drivers are fabricated on array (GOA). The LCD comprises a controller, a source driver, a gate driving unit, and a panel. The panel comprises a pixel array section. When clock signals and controlling signals of gate drivers are transmitted to the gate driving unit, the gate driving unit will generate a scanning signal and transmit the scanning signal to pixels arranged in the pixel array section. Meanwhile, the source driver will output a grayscale voltage to the pixels arranged in the pixel array section.

The both sides of the panel are just where the sealant is coated. Vapors may seep down to the sealant due to ageing, poor quality, poor coating, or other cause, resulting in short circuits among controlling signals of the GOA circuits and further burning the panel out.

### SUMMARY OF THE INVENTION

To solve the technical problem that the substrate may be burnt out in the conventional technology, an LCD comprising a substrate against burnout should be proposed.

According to the present invention, a liquid crystal display (LCD) comprises a gate driver on array (GOA) substrate. The substrate comprises a pixel array section and a circuit arrangement section arranged on a first side and a second side of the pixel array section. The first side and the second side are in parallel. The LCD further comprises: a plurality of gate driving units connected in series, disposed on the circuit arrangement section, for outputting a scanning signal to the pixel array section based on a voltage level of a clock signal and a voltage level of a controlling signal; a sensing circuit, electrically connected to the gate driving unit at the last stage, for outputting an adjusting signal when the scanning signal output by the gate driving unit at the last stage, or output by the gate driving unit at the second-last stage, or output by the gate driving unit at the third-last stage is smaller than a predetermined value; and a level shifter, electrically connected to the plurality of gate driving units and the sensing circuit, for outputting clock signal at a low voltage level and controlling signal at a low voltage level to the plurality of gate driving units when receiving the adjusting signal.

In one another aspect of the present invention, the LCD further comprises a source driver, the substrate further comprises a third side, the third side is perpendicular to the first side and the second side, and the plurality of source drivers are arranged on the third side.

In another aspect of the present invention, each of the plurality of gate driving units comprises: a first transistor, comprising a drain electrically connected to the clock signal, a source electrically connected to an output terminal for outputting the scanning signal, and a gate electrically connected to a trigger node; a second transistor, comprising a drain electrically connected to the clock signal, a source electrically connected to a controlling terminal for outputting the controlling signal, and a gate electrically connected to the trigger node; a third transistor, comprising a drain electrically connected to the output terminal and a source electrically connected to a supply voltage; and a fourth transistor, comprising a drain electrically connected to the trigger node, a source electrically connected to the supply voltage, and a gate electrically connected to a gate of the third transistor.

In still another aspect of the present invention, the plurality of gate driving units stop outputting the scanning signal when the level shifter outputs the clock signals at the low voltage level and the controlling signals at the low voltage level to the plurality of gate driving units.

In yet another aspect of the present invention, the level shifter outputs the clock signal at a high voltage level and the controlling signal at a high voltage level to the plurality of gate driving units when receiving the adjusting signal. According to the present invention, a liquid crystal display (LCD) comprises a gate driver on array (GOA) substrate. The substrate comprises a pixel array section and a circuit arrangement section arranged on a first side and a second side of the pixel array section. The first side and the second side are in parallel. The LCD further comprises: a plurality of gate driving units connected in series, disposed on the circuit arrangement section, for outputting a scanning signal to the pixel array section based on a voltage level of a clock signal and a voltage level of a controlling signal; a sensing circuit, electrically connected to the gate driving unit at the last stage, for outputting an adjusting signal when an output signal output by the gate driving unit at the last stage, or output by the gate driving unit at the second-last stage, or output by the gate driving unit at the third-last stage is smaller than a predetermined value; and a level shifter, electrically connected to the plurality of gate driving units and the sensing circuit, for outputting clock signal at a low voltage level and controlling signal at a low voltage level to the plurality of gate driving units when receiving the adjusting signal.

In one aspect of the present invention, the LCD further comprises a source driver, the substrate further comprises a third side, the third side is perpendicular to the first side and the second side, and the plurality of source drivers are arranged on the third side.

In another aspect of the present invention, the LCD further comprises a flexible printed circuit, and the flexible printed circuit is used for being electrically connected to the plurality of source drivers and the pixel array section.

In another aspect of the present invention, each of the plurality of gate driving units comprises: a first transistor, comprising a drain electrically connected to the clock signal, a source electrically connected to an output terminal for outputting the scanning signal, and a gate electrically connected to a trigger node; a second transistor, comprising a drain electrically connected to the clock signal, a source electrically connected to a controlling terminal for outputting the controlling signal, and a gate electrically connected to the trigger node; a third transistor, comprising a drain electrically connected to the output terminal and a source electrically connected to a supply voltage; and a fourth transistor, comprising a drain electrically connected to the trigger node, a source electrically connected to the supply voltage, and a gate electrically connected to a gate of the third transistor.

In another aspect of the present invention, the output signal is a controlling signal output by the gate driving unit at the last stage, or output by the gate driving unit at the second-last stage, or output by the gate driving unit at the third-last stage.

In another aspect of the present invention, the output signal is a signal output by the trigger node of the gate driving unit at the last stage, or output by the gate driving unit at the second-last stage, or output by the gate driving unit at the third-last stage.

In another aspect of the present invention, the plurality of gate driving units stop outputting the scanning signal when the level shifter outputs the clock signals at the low voltage level and the controlling signals at the low voltage level to the plurality of gate driving units.

In still another aspect of the present invention, the level shifter outputs the clock signal at a high voltage level and the controlling signal at a high voltage level to the plurality of gate driving units when receiving the adjusting signal.

In yet another aspect of the present invention, the sensing circuit is integrated in the level shifter.

Compared with the conventional LCD, the LCD proposed by the present invention further comprises a sensing circuit. The sensing circuit is used for outputting an adjusting signal when an output signal output by the gate driving unit at the last stage is smaller than a predetermined value. The level shifter receives the adjusting signal and then outputs the clock signals at the low voltage level and a controlling signal at the low voltage level to a plurality of gate driving units so that the plurality of gate driving units stop outputting the scanning signal and meanwhile, data transmission is closed. So the LCD is turned off for a while, and a black image shows. In this way, it is impossible to burn the substrate out.

These and other objectives of the present invention will become apparent to those of ordinary skill in the art after reading the following detailed description of the preferred embodiment that is illustrated in the various figures and drawings.

### BRIEF DESCRIPTION OF THE DRAWINGS

FIG. 1 is a schematic diagram of an LCD 10 adopting a substrate according to the present invention.

FIG. 2 is a circuit diagram of a part of the gate driving unit.

FIG. 3 is a schematic diagram of the sensing circuit and the level shifter shown in FIG. 1.

FIG. 4 is a schematic diagram of the sensing circuit determining an output signal GOA_FB of the gate driving unit at the last stage.

### DETAILED DESCRIPTION OF THE PREFERRED EMBODIMENTS

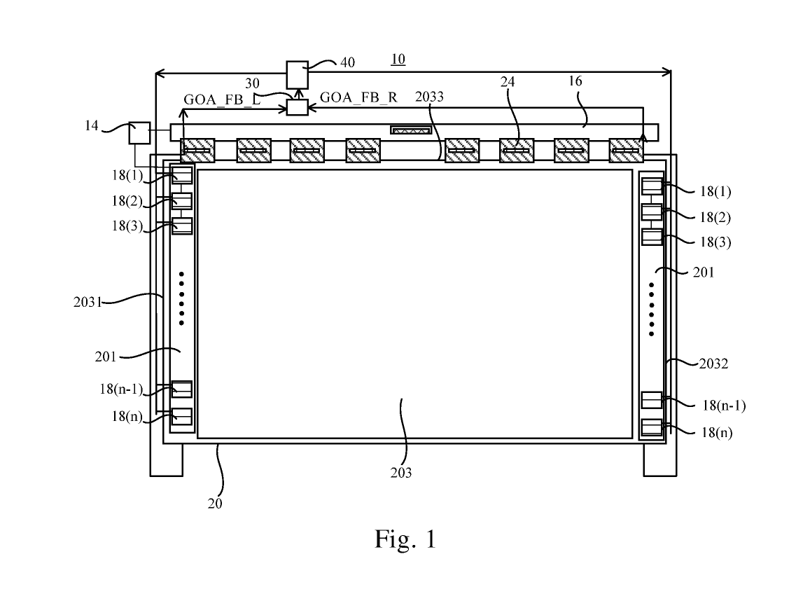

Please refer to FIG. 1. FIG. 1 is a schematic diagram of an LCD 10 with gate driver on array according to the present invention. The LCD 10 comprises a controller 14, a source driver 16, a plurality of gate driving units 18(1)˜18(n), a sensing circuit 30, and a substrate 20. The substrate 20 comprises a first side 2031, a second side 2032, and a third side 2033. The first side 2031 and the second side 2032 are in parallel. The third side 2033 is perpendicular to the first side 2031 and the second side 2032. The substrate 20 comprises a pixel array section 203 and a circuit arrangement section 201 arranged on both sides of the pixel array section 203. The plurality of gate driving units 18(1)˜18(n) (i.e., GOA circuit units) are arranged on the circuit arrangement section 201. The source driver 16 is arranged on the third side 2033 of the substrate 20. The source driver 16 is electrically connected to pixels arranged on the pixel array section 203 through a flexible printed circuit (FPC) 24. The plurality of gate driving units 18(1)˜18(n) will generate a scanning signal and transmit the scanning signal to the pixel of the pixel array section 203 when a clock signal generated by the controller 14 and a GOA controlling signal generated by the controller 14 are transmitted to the plurality of gate driving units 18(1)˜18(n). The source driver 16 will output a grayscale voltage to the pixels arranged on the pixel array section 203 at the same time.

The plurality of gate driving units 18(1)˜18(n) shown in FIG. 1 are connected in a sequence. The plurality of gate driving units 18(1)˜18(n) are connected to the plurality of rows of pixels in the pixel array section 203 one-on-one. For example, an LCD panel with the resolution of 1024×768 comprises 768 gate driving units 18. The R, G, B sub-pixels are arranged horizontally. Each of the plurality of gate driving units 18(1)˜18(n) is connected to a row of pixels where n is 768.

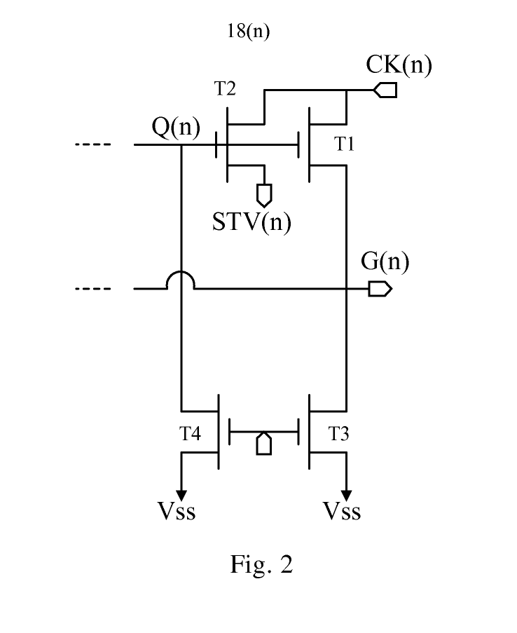

Please refer to FIG. 2. FIG. 2 is a circuit diagram of a part of the gate driving unit 18(n). The circuit of each of the plurality of gate driving units 18 is identical. Only the circuit of the gate driving unit 18(n) is described herein. The gate driving unit 18(n) comprises a first transistor T1, a second transistor T2, a third transistor T3, and a fourth transistor T4. The first transistor T1 comprises a drain electrically connected to the clock signal CK(n), a source electrically connected to the output terminal G(n) for outputting the scanning signal, and a gate electrically connected to a trigger node Q(n). The second transistor T2 comprises a drain electrically connected to the clock signal CK(n), a source electrically connected to the controlling terminal STV(n) for outputting the controlling signal, and a gate electrically connected to the trigger node Q(n). The third transistor T3 comprises a drain electrically connected to the output terminal G(n) and a source electrically connected to a supply voltage Vss. The fourth transistor T4 comprises a drain electrically connected to the trigger node Q(n), a source electrically connected to the supply voltage Vss, and a gate electrically connected to a gate of the third transistor T3. When the signal level of the trigger node Q(n) is a high voltage level, the first transistor T1 and the second transistor T2 are turned on so that the clock signal CK(n) at the high voltage level can be transmitted to the output terminal G(n) and the controlling terminal STV(n). At this time, both of the scanning signal output by the output terminal G(n) and the controlling signal of the controlling terminal STV(n) are at the high voltage level. Correspondingly, when the signal level of the trigger node Q(n) is a low voltage level, the first transistor T1 and the second transistor T2 are turned off while both of the third transistor T3 and the fourth transistor T4 are turned on and conduct the supply voltage Vss. Meanwhile, the scanning signal output by the output terminal G(n) is at the low voltage level.

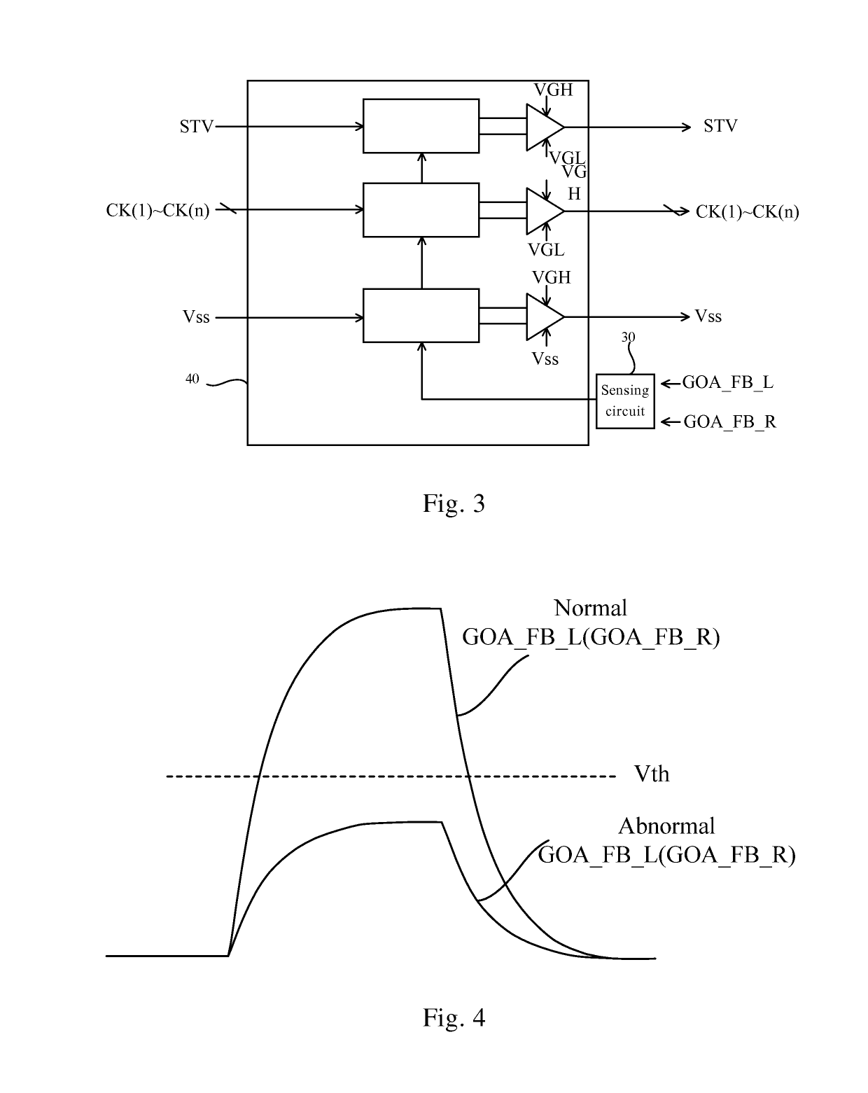

Please refer to FIG. 3 and FIG. 4. FIG. 3 is a schematic diagram of the sensing circuit and the level shifter shown in FIG. 1. FIG. 4 is a schematic diagram of the sensing circuit determining an output signal GOA_FB of the gate driving unit at the last stage. The sensing circuit 30 is electrically connected to the gate driving unit 18(n) at the last stage and used for outputting an adjusting signal when an output signal GOA_FB_L (or GOA_FB_R) output by the gate driving unit 18(n) at the last stage is smaller than a predetermined value Vth. The output signal GOA_FB_L (or GOA_FB_R) may be a scanning signal G(n) of the gate driving unit 18(n) at the last stage, or a controlling signal STV(n) of the gate driving unit 18(n) at the last stage, or a signal of the trigger node Q(n) of the gate driving unit 18(n) at the last stage. The level shifter 40 is electrically connected to the plurality of gate driving units 18(1)˜18(n) and the sensing circuit 30 and used for outputting the clock signals CK(1)˜CK(n) at the low voltage level and the controlling signals STV(1)˜STV(n) at the low voltage level to the plurality of gate driving units 18(1)˜18(n) when receiving the adjusting signal. When the level shifter 40 outputs the clock signals CK(1)˜CK(n) at the low voltage level and the controlling signals STV(1)˜STV(n) at the low voltage level to the plurality of gate driving units 18(1)˜18(n), the plurality of gate driving units 18(1)˜18(n) stop outputting the scanning signal. When not receiving the adjusting signal, the level shifter 40 outputs the clock signals CK(1)˜CK(n) at the high voltage level and the controlling signals STV(1)˜STV(n) at the high voltage level to the plurality of gate driving units 18(1)˜18(n) so that the plurality of gate driving units 18(1)˜18(n) can output the scanning signal to the pixel array section 203.

It is should be notified that the sensing circuit 30 is electrically connected to the gate driving unit 18(n) at the last stage and used for outputting the adjusting signal when the output signal output by the gate driving unit 18(n) at the last stage is smaller than the predetermined value in the present embodiment. However, the sensing circuit 30 may be electrically connected to a gate driving unit 18(n-1) and used for outputting an adjusting signal when a scanning signal G(n-1) of the gate driving unit 18(n-1), or a controlling signal STV(n-1), or a signal of a trigger node Q(n-1) is smaller than the predetermined value in another embodiment. Furthermore, in another embodiment, the sensing circuit 30 may be electrically connected to a gate driving unit 18(n-2) and used for outputting an adjusting signal when a scanning signal G(n-2) of the gate driving unit 18(n-2), or a controlling signal STV(n-2), or a signal of a trigger node Q(n-2) is smaller than the predetermined value in another embodiment.

The LCD proposed by the present invention is not limited to being adopted in the above-mentioned embodiments. For example, the sensing circuit 30 can also be integrated in the source driver 16. The operation principle for the sensing circuit 30 is of no differences.

To sum up, the LCD proposed by the present invention further comprises a sensing circuit. The sensing circuit is used for outputting an adjusting signal when an output signal output by the gate driving unit at the last stage is smaller than a predetermined value. The level shifter is determined to output the clock signals at the low voltage level and the controlling signal at the low voltage level to the plurality of gate driving units when receiving the adjusting signal so that the plurality of gate driving units stop outputting the scanning signal and meanwhile, data transmission is closed. In this way, the LCD is turned off for a while, and a black image shows. Therefore, the substrate prevents being burnt out.

While the invention has been described by way of example and in terms of the preferred embodiments, it is to be understood that the invention is not limited to the disclosed embodiments. To the contrary, it is intended to cover various modifications and similar arrangements.

What is claimed is:

1. A liquid crystal display (LCD), comprising a gate driver on array (GOA) substrate, the substrate comprising a pixel array section and a circuit arrangement section arranged on a first side and a second side of the pixel array section, the first side and the second side being in parallel, and the LCD further comprising:
a plurality of gate driving units connected in series, disposed on the circuit arrangement section, for outputting a scanning signal to the pixel array section based on a voltage level of a clock signal and a voltage level of a controlling signal;
a sensing circuit, electrically connected to the gate driving unit at the last stage, for outputting an adjusting signal when the scanning signal output by the gate driving unit at the last stage, or output by the gate driving unit at the second-last stage, or output by the gate driving unit at the third-last stage is smaller than a predetermined value; and
a level shifter, electrically connected to the plurality of gate driving units and the sensing circuit, for outputting clock signal at a low voltage level and controlling signal at a low voltage level to the plurality of gate driving units when receiving the adjusting signal.

2. The LCD of claim 1, wherein the LCD further comprises a source driver, the substrate further comprises a third side, the third side is perpendicular to the first side and the second side, and the plurality of source drivers are arranged on the third side.

3. The LCD of claim 1, wherein each of the plurality of gate driving units comprises:
a first transistor, comprising a drain electrically connected to the clock signal, a source electrically connected to an output terminal for outputting the scanning signal, and a gate electrically connected to a trigger node;
a second transistor, comprising a drain electrically connected to the clock signal, a source electrically connected to a controlling terminal for outputting the controlling signal, and a gate electrically connected to the trigger node;
a third transistor, comprising a drain electrically connected to the output terminal and a source electrically connected to a supply voltage; and
a fourth transistor, comprising a drain electrically connected to the trigger node, a source electrically connected to the supply voltage, and a gate electrically connected to a gate of the third transistor.

4. The LCD of claim 1, wherein the plurality of gate driving units stop outputting the scanning signal when the level shifter outputs the clock signals at the low voltage level and the controlling signals at the low voltage level to the plurality of gate driving units.

5. The LCD of claim 4, wherein the level shifter outputs the clock signal at a high voltage level and the controlling signal at a high voltage level to the plurality of gate driving units when not receiving the adjusting signal so that the plurality of gate driving units outputs the scanning signal to the pixel array section.

6. A liquid crystal display (LCD), comprising a gate driver on array (GOA) substrate, the substrate comprising a pixel array section and a circuit arrangement section arranged on a first side and a second side of the pixel array section, the first side and the second side being in parallel, and the LCD further comprising:
a plurality of gate driving units connected in series, disposed on the circuit arrangement section, for outputting a scanning signal to the pixel array section based on a voltage level of a clock signal and a voltage level of a controlling signal;
a sensing circuit, electrically connected to the gate driving unit at the last stage, for outputting an adjusting signal when an output signal output by the gate driving unit at the last stage, or output by the gate driving unit at the second-last stage, or output by the gate driving unit at the third-last stage is smaller than a predetermined value; and
a level shifter, electrically connected to the plurality of gate driving units and the sensing circuit, for outputting clock signal at a low voltage level and controlling signal at a low voltage level to the plurality of gate driving units when receiving the adjusting signal.

7. The LCD of claim 6, wherein the LCD further comprises a source driver, the substrate further comprises a third side, the third side is perpendicular to the first side and the second side, and the plurality of source drivers are arranged on the third side.

8. The LCD of claim 7, wherein the LCD further comprises a flexible printed circuit, and the flexible printed circuit is used for being electrically connected to the plurality of source drivers and the pixel array section.

9. The LCD of claim 6, wherein each of the plurality of gate driving units comprises:
a first transistor, comprising a drain electrically connected to the clock signal, a source electrically connected to an output terminal for outputting the scanning signal, and a gate electrically connected to a trigger node;
a second transistor, comprising a drain electrically connected to the clock signal, a source electrically connected to a controlling terminal for outputting the controlling signal, and a gate electrically connected to the trigger node;
a third transistor, comprising a drain electrically connected to the output terminal and a source electrically connected to a supply voltage; and
a fourth transistor, comprising a drain electrically connected to the trigger node, a source electrically connected to the supply voltage, and a gate electrically connected to a gate of the third transistor.

10. The LCD of claim 9, wherein the output signal is a controlling signal output by the gate driving unit at the last stage, or output by the gate driving unit at the second-last stage, or output by the gate driving unit at the third-last stage.

11. The LCD of claim 9, wherein the output signal is a signal output by the trigger node of the gate driving unit at the last stage, or output by the gate driving unit at the second-last stage, or output by the gate driving unit at the third-last stage.

12. The LCD of claim 6, wherein the plurality of gate driving units stop outputting the scanning signal when the level shifter outputs the clock signals at the low voltage level and the controlling signals at the low voltage level to the plurality of gate driving units.

13. The LCD of claim 12, wherein the level shifter outputs the clock signal at a high voltage level and the controlling signal at a high voltage level to the plurality of gate driving units when not receiving the adjusting signal so that the plurality of gate driving units outputs the scanning signal to the pixel array section.

14. The LCD of claim 6, wherein the sensing circuit is integrated in the level shifter.
